(19) United States
(12) Patent Application Publication
(10) Pub. No.: US 2025/0030711 A1
(43) Pub. Date: Jan. 23, 2025

(54) SYSTEM AND METHOD OF USER TRACKING BY DIGITAL HANDPRINT

(71) Applicant: Honeypot Technologies LLC, Sheridan, WY (US)

(72) Inventor: Mitchell Williams Seymour, Suwanee, GA (US)

(73) Assignee: Honeypot Technologies LLC, Sheridan, WY (US)

(21) Appl. No.: 18/354,980

(22) Filed: Jul. 19, 2023

(51) Int. Cl. H04L 9/40

(52) U.S. Cl. CPC H04L 63/1425; H04L 63/0272; H04L 63/0876; H04L 63/166

(57) ABSTRACT

Disclosed is a method for tracking a malicious user. The method receives a plurality of client-side attributes indicative of a first unique client-identifier, generates a first tampering signal confidence value based on the client-side attributes collected for the first unique client-identifier, and transmits the first unique client-identifier and one or more secondary attributes indicating a second unique client-identifier to a server. The processor combines the secondary attributes with additional client networking information, including one or more of an Internet Protocol (IP) address of a client device and a Transport Layer Security (TLS) fingerprint of a client device, to create a second unique client-identifier. The processor determines that a second unique client identifier signal strength value meets a predetermined threshold value. If the first unique client identifier or the second unique client-identifier is not present in a database, the processor creates a third unique client-identifier to track the malicious user.

### BACKGROUND

### Technical Field

The invention presented herein is generally directed toward a system and method for tracking malicious users and bots. More particularly, a system and method to track a unique client identifier (fingerprint) associated with a malicious user.

### Description of the Related Art

The malicious or undesirable behavior of users on digital platforms poses several problems for companies. One of the primary concerns for companies is the safety of their users. If users engage in inappropriate or malicious behavior, it can put other users at risk. For example, cyberbullying, hate speech, and harassment can create a hostile environment that discourages users from participating in the platform. This can lead to a loss of users, decreased engagement, damage to the platform's reputation, and an increase in legal and support costs for companies. Another concern is inorganic traffic caused by bots. Bot traffic can put strain on a platform's infrastructure and software, degrade the experience for organic users, and increase the operational, legal, and support costs for companies.

To mitigate these problems, companies often implement measures to prevent and monitor malicious user behavior. This may include moderation policies, user reporting systems, and both automated and manual detection systems for malicious activity. However, these measures can be challenging to implement effectively, and there is always a risk that some malicious behavior will go unnoticed.

Many companies have terms of service (TOS), which specify the rules for utilizing their products and services, and failure to adhere to them may result in penalties such as being banned from the platform. There are many types of moderation actions a company may take against malicious users or bots, but we will collectively refer to any moderation as being “banned” throughout this document. Examples of TOS violations include engaging in cyberbullying on social media, infringing on copyright in online galleries or marketplaces, committing financial fraud, using unauthorized bots, credential stuffing and account impersonation, and other unwanted behavior. However, some users may be able to circumvent the consequences of being banned by creating a new account or otherwise becoming disassociated from their prior account or reputation by another means. The specifics of creating a new account may differ depending on the platform, but it can entail generating new usernames, email addresses, or crypto wallet addresses (for web3 companies), or any other process that does not require a Know Your Customer (KYC) workflow. Further examples that users can leverage to circumvent moderation or become disassociated from their prior reputation include changing IP addresses, hardware, or client software.

This leads to various challenges such as 1) understanding a user's reputation is difficult if they create a brand-new account, change their client or networking properties, or otherwise become disassociated from their previous accounts and behaviors; 2) companies waste time and resources chasing after malicious users and bots. They must re-detect violations and re-apply enforcement actions; and 3) the company's ability to enforce their terms of service is severely undermined, putting their product, service and reputation at risk.

Currently, fingerprinting technology is used for enhanced user and bot tracking. Fingerprinting involves combining different attributes of a client's browser and/or device to identify unique users. Fingerprinting is distinct from cookie-based approaches to tracking. Unlike cookies, fingerprints do not need to be stored by the client (e.g., web browsers). Instead, the signals are stored by a server-side component. However, there are various challenges with the current fingerprinting technology such as 1) tampering of client properties, 2) client properties, alone, are not sufficient to track users across different browsers or WebDrivers (e.g., those that are used directly by bots) even on the same device, and 3) access to device hardware and networking information is extremely limited in some clients, like web browsers. For example, current fingerprinting technology cannot access information like a MAC address from a web browser and collecting client network information requires additional client-server coordination. Also, the current fingerprinting technology is too narrowly applied, often tracking either a single client or a device fingerprint, or otherwise lacking a sufficient combination of multiple fingerprints in order to accurately track users. This specification recognizes that there is a need for a system and method that can combine a wider and richer set of signals in order to create a more comprehensive fingerprinting technology for tracking malicious users.

Thus, in view of the above, there is a long-felt need in the industry to address the aforementioned deficiencies and the inadequate limited tracking of malicious users.

It is with respect to these and other considerations that the disclosure made herein is presented.

### SUMMARY

A system for tracking a malicious user is provided, as shown in and/or described in connection with at least one of the figures.

One aspect of the present disclosure relates to a system for tracking a malicious user. The system includes a processor; and a memory. The memory is communicatively coupled to the processor, wherein the memory stores a plurality of instructions, which, on execution, causes the processor to receive a plurality of client-side attributes that are combined to create a first unique client identifier. The processor is configured to generate based on pre-processing data; a first tampering signal confidence value based on the client-side attributes collected for the first unique client identifier. The processor is configured to transmit the first unique client identifier and one or more secondary attributes to a server. The secondary attributes pertain to hardware and networking information and are used to construct a second unique client identifier. The processor is configured to combine the secondary attributes with additional networking information of a client, including one or both of an Internet Protocol (IP) address of a client device and a Transport Layer Security (TLS) fingerprint of a client device by executing a server-side script. The processor is configured to create the second unique client identifier based on the secondary attributes and the networking identifiers of the client device. The processor is further configured to determine that a second unique client identifier signal strength value of the client device meets a predetermined threshold value and apply an additional signal responsive to determining that the second unique client identifier meets the threshold value. The system may reduce a second unique client identifier signal strength upon determining one or more of an association of the IP address with a virtual private network (VPN), an identification of the IP address as a shared IP address, an identification of anonymized traffic source, an identification of a manipulated network connection, and an identification of one or more manipulated network attributes. Responsive to determining the second unique client identifier of the client device meets the required threshold value, the processor is configured to determine that one or more of the first unique client identifier and the second unique client identifier are not present in a database. The processor is configured to create a third unique client identifier responsive to determining that the first unique client identifier and the second unique client identifier are not present in the database. In an aspect, the processor may create the third unique client identifier by generating a universally unique identifier (UUID) and assigning the newly generated UUID to the first client identifier and the second client identifier, such that any future search against either the first client identifier or the second client identifier will return the UUID that represents the third unique client identifier.

In an aspect, the processor is configured to transmit an instruction to execute a client-side tamper detection script to generate the first tampering signal confidence value.

In an aspect, the processor is configured to retrieve the third unique client identifier from the database responsive to determining that the one or more of the first unique client identifier, and the second unique client identifier are present in the database.

In an aspect, the processor is configured to transmit a command to a backend server to trigger the query to the database to determine whether the first unique client identifier is present in the database, responsive to determining that the second unique client identifier of the client device does not meet the threshold value.

In an aspect, the processor is configured to create the third unique client identifier responsive to determining that the first unique client identifier is not present in the database.

In an aspect, the processor is configured to retrieve the third unique client identifier from the database, responsive to determining that the first unique client identifier is present in the database.

In an aspect, the third unique client identifier is created upon determining that the first unique client identifier does not exist in the database. In another aspect, the third unique client identifier is created when the second unique client identifier has an adequate signal strength and the second unique client identifier is also not found in the database.

Examples of the client-side attributes include but are not limited to navigator data, a plurality of canvas fingerprints and canvas unique client identifiers, and a plurality of WebGL unique client identifiers.

Examples of the secondary attributes include but are not limited to a screen height, a screen width, a navigator platform, and WebGL data.

Another aspect of the present disclosure relates to a method for tracking a malicious user. The method can include receiving, by a processor, a plurality of client-side attributes indicative of a first unique client identifier. The method further includes generating, by the processor, based on pre-processing data, a first tampering signal confidence value based on the attributes collected for the first client identifier. This may further include transmitting, by the processor, the first unique client identifier and one or more secondary attributes to a server. The one or more secondary attributes are indicative of a second unique client identifier. The method may further include combining, by the processor, the one or more secondary attributes with additional networking information of a client, including one or both of an Internet Protocol (IP) address of a client device and a Transport Layer Security (TLS) fingerprint of a client device by executing a server-side script. The system may create, by the processor, the second unique client identifier based on the secondary attributes and the networking information of the client device. The method further includes determining, by the processor, that a second unique client identifier signal strength value of the client device meets a threshold value, and applying an additional signal. The system may reduce the second unique client identifier signal strength upon determining one or more of an association of the IP address with a virtual private network (VPN), an identification of the IP address as a shared IP address, an identification of an anonymized traffic source, an identification of a manipulated network connection, and an identification of one or more manipulated network attributes. The method includes a step of determining that one or more of the first unique client identifier and the second unique client identifier are not present in a database, responsive to determining, by the processor, the second unique client identifier of the client device meets the threshold value. The method includes a step of creating, by the processor, a third unique client identifier responsive to determining that the first unique client identifier and the second unique client identifier are not present in the database. The third unique client identifier is created by combining the first unique client identifier and the second unique client identifier to track the malicious user, for example, by generating a universally unique identifier (UUID) and assigning the newly generated UUID to the first client identifier and the second client identifier, such that any future search against either the first client identifier or the second client identifier will return the UUID that represents the third unique client identifier. The method includes a step of transmitting, by the processor, an instruction to execute a client-side tamper detection script to generate the first tampering signal confidence value. The method includes a step of retrieving, by the processor, the third unique client identifier from the database responsive to determining that the one or more of the first unique client identifier, and the second client hardware identifier are present in the database. The method includes a step of transmitting, by the processor, a command to a backend server to trigger the query to the database to determine whether the first unique client identifier present in the database, responsive to determining that the second unique client identifier of the client device does not meet the threshold value. The method includes a step of creating, by the processor, the third unique client identifier responsive to determining that the first unique client identifier is not present in the database. The method includes a step of retrieving, by the processor, the third unique client identifier from the database, responsive to determining that the first unique client identifier is present in the database.

In an aspect, the third unique client identifier is created upon determining that the first unique client identifier does not exist in the database.

Examples of the client-side attributes include but are not limited to navigator data, a plurality of canvas unique client identifiers, and a plurality of WebGL unique client identifiers.

Examples of the secondary attributes include but are not limited to a screen height, a screen width, a navigator platform, and WebGL data.

In an aspect, the first unique client identifier is a browser, mobile application, or another identifier representing a user interface.

In an aspect, the second unique client identifier is a device-unique identifier representing hardware and networking information for the client

In an aspect, the third unique client identifier is a universally unique identifier (UUID).

In an aspect, the first unique client identifier, the second unique client identifier, and the third unique client identifier are stored in the database.

Another aspect of the present disclosure relates to a non-transitory computer-readable storage medium in a distributed computing system, the non-transitory computer-readable storage medium having instructions stored thereupon which, when executed by a processor, cause the processor to receive a plurality of client-side attributes indicative of a first unique client identifier. The processor is configured to generate based on pre-processing data, a first tampering signal confidence value based on the client-side attributes collected for the first unique client identifier. The processor is configured to transmit the first unique client identifier and one or more secondary attributes to a server. The secondary attributes are indicative of a second unique client identifier. The processor is configured to combine the secondary attributes with additional networking information of a client, including one or both of an Internet Protocol (IP) address and a TLS fingerprint of a client device by executing a server-side script. The processor is configured to create the second unique client identifier based on the secondary attributes and the networking information (one or both of an IP address and TLS fingerprint) of the client device. The processor is configured to determine that a second unique client identifier signal strength value of the client device meets a predetermined threshold value. The processor is configured to apply an additional signal. The second unique client identifier signal strength is reduced upon determining one or more of an association of the IP address with a virtual private network (VPN), an identification of the IP address as a shared IP address, an identification of an anonymized traffic source, an identification of a manipulated network connection, and an identification of one or more manipulated network attributes. Responsive to determining the second unique client identifier of the client device meets the threshold value, the processor is configured to determine that one or more of the first unique client identifier and the second unique client identifier are present in a database. The processor is configured to create a third unique client identifier responsive to determining that the first unique client identifier and the second unique client identifier are not present in the database. The third unique client identifier is created by combining the first unique client identifier and the second unique client identifier to track the malicious user, for example, by generating a universally unique identifier (UUID) and assigning the newly generated UUID to the first client identifier and the second client identifier, such that any future search against either the first client identifier or the second client identifier will return the UUID that represents the third unique client identifier. In an aspect, the processor is configured to transmit an instruction to execute a client-side tamper detection script to generate the first tampering signal confidence value.

In an aspect, the processor is configured to retrieve the third unique client identifier from the database responsive to determining that the one or more of the first unique client identifier, and the second unique client identifier are present in the database.

In an aspect, the processor is configured to transmit a command to a backend server to trigger the query to the database to determine whether the first unique client identifier is present in the database, responsive to determining that the second unique client identifier of the client device does not meet the threshold value.

In an aspect, the processor is configured to create the third unique client identifier responsive to determining that neither the first unique client identifier nor the second unique client identifier are present in the database.

In an aspect, the processor is configured to retrieve the third unique client identifier from the database, responsive to determining that the first unique client identifier is present in the database.

Other embodiments and advantages will become readily apparent to those skilled in the art upon viewing the drawings and reading the detailed description hereafter, all without departing from the scope of the disclosure. The drawings and detailed descriptions presented are to be regarded as illustrative in nature and not in any way as restrictive.

Other features of the example embodiments will be apparent from the drawings and from the detailed description that follows.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a block diagram that illustrates a system environment in which various embodiments of the method and the system may be implemented.

FIG. 2 is a block diagram that illustrates a server configured to track a malicious user, in accordance with at least one embodiment.

FIG. 3 illustrates a perspective view of the creation of the third unique client identifier by combining the first unique client identifier, and the second unique client identifier for tracking a malicious user, in accordance with at least one embodiment.

FIG. 4 illustrates a perspective view of tracking the malicious user even if the client and browser changes, in accordance with at least one embodiment.

FIG. 5 is a flowchart that illustrates a method for tracking a malicious user, in accordance with at least one embodiment.

### DETAILED DESCRIPTION

The disclosure will be described more fully hereinafter with reference to the accompanying drawings, in which example embodiments of the disclosure are shown, and not intended to be limiting.

Aspects of the present disclosure relate to a system that tracks malicious users to help companies reduce malicious or undesirable behavior on their digital platforms and provide a clearer understanding of a company's user base. Further, the system of the present disclosure validates and combines the first unique client identifier, and the second unique client identifier to create an improved identifier, such as, for example, the third unique client identifier for tracking malicious users. There are many types of moderation actions a company may take against malicious users or bots. However, the present disclosure collectively refers to any moderation as being “banned”.

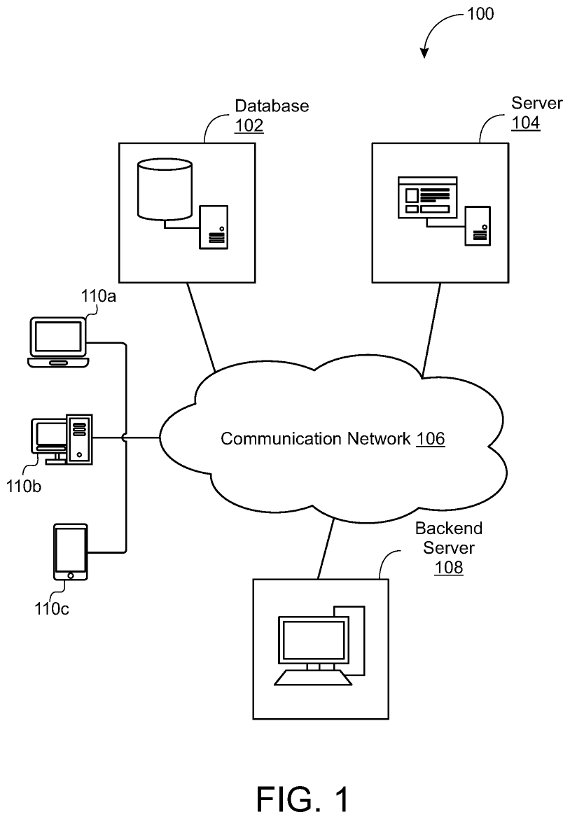

FIG. 1 is a block diagram that illustrates a system environment 100 in which various embodiments of the method and the system may be implemented. The system environment 100 may include a database 102, a server 104, a communication network 106, a backend server 108, and one or more client devices 110a, 110b, and 110c collectively referred to as the client device 110. In an embodiment, the client device 110 is a device that is used by a user to access one or more digital platforms associated with one or more companies. Examples of digital platforms include but are not limited to a mobile application, a website, a social media website, and an e-commerce website. Examples of the users may include but are not limited to a human being and a software bot, etc.

In an embodiment, the database 102, the server 104, the backend server 108, and the client devices 110 may be communicatively coupled with each other via the communication network 106. In an embodiment, the server 104 may communicate with the database 102 using one or more protocols such as, but not limited to, Open Database Connectivity (ODBC) protocol and Java Database Connectivity (JDBC) protocol. In an embodiment, the backend server 108, and the client device 110 may communicate with the server 104, via the communication network 106. Examples of the client device 110 may include but are not limited to, a personal computer, a laptop, a personal digital assistant (PDA), a mobile device, a tablet, or any other computing device.

In an embodiment, the database 102 may refer to a computing device that may be configured to store data related to one or more unique client identifiers (e.g., device fingerprints). As used in the present disclosure, the individual unique client identifiers may be referenced individually as a first unique client identifier, a second unique client identifier, and a third unique client identifier.

In an embodiment, the database 102 may include a special-purpose operating system specifically configured to perform one or more database operations on data related to the first unique client identifier, the second unique client identifier, and the third unique client identifier. Examples of database operations may include, but are not limited to, Select, Insert, Update, and Delete. In an embodiment, the database 102 may include hardware that may be configured to perform one or more predetermined operations. In an embodiment, the database 102 may be realized through various technologies such as, but not limited to, relational databases, graph databases, NoSQL databases, document databases, key-value stores, column-oriented databases, data warehouses, and other technologies designed to facilitate data storage and retrieval.

The database 102 may be configured to transmit the data to the server 104 for data processing, via the communication network 106. In an embodiment, the database 102 may be configured to transmit the data to the server 104 and the backend server 108 at one or more locations for showcasing the details of the malicious users.

A person with ordinary skills in the art will understand that the scope of the disclosure is not limited to the database 102 as a separate entity. In an embodiment, the functionalities of the database 102 can be integrated into the server 104.

In an embodiment, the server 104 may refer to a computing device or a software framework hosting an application or a software service. In an embodiment, the server 104 may be implemented to execute procedures such as, but not limited to, programs, routines, or scripts stored in one or more memories for supporting the hosted application or the software service. In an embodiment, the hosted application or the software service may be configured to perform one or more predetermined operations. The server 104 may be realized through various types of web or application servers such as, but are not limited to, a Python web server, a NodeJS web server, Java application server, a .NET framework application server, a Base4 application server, a PHP framework application server, or any other application server framework.

A person having ordinary skill in the art will appreciate that the scope of the disclosure is not limited to realizing the server 104, the backend server 108, and the client devices 110 as separate entities.

In one embodiment, the communication network 106 may correspond to a communication medium through which the database 102, the server 104, the backend server 108, and the client devices 110 may communicate with each other. Such communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 106 may include but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

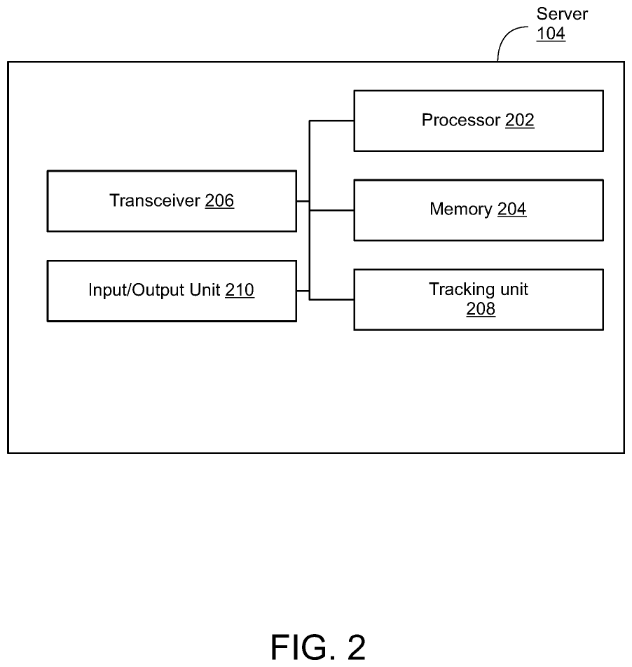

FIG. 2 is a block diagram that illustrates a server 104 configured to track a malicious user, in accordance with at least one embodiment. FIG. 2 is explained in conjunction with elements from FIG. 1. In an embodiment, the server 104 includes a processor 202, a memory 204, a transceiver 206, a tracking unit 208, and an input/output unit 210. The processor 202 may be communicatively coupled to the memory 204, the transceiver 206, the tracking unit 208, and the input/output unit 210. The transceiver 206 may be communicatively coupled to the communication network 106.

The processor 202 includes suitable logic, circuitry, interfaces, and/or code that may be configured to execute a set of instructions stored in the memory 204. The processor 202 may be implemented based on several processor technologies known in the art. The processor 202 works in coordination with the transceiver 206, the tracking unit 208, and the input/output unit 210 to receive, store, manage, and process data related to the first unique client identifier, the second unique client identifier, and the third unique client identifier. Examples of the processor 202 include but are not limited to, an X86-based processor, a Reduced Instruction Set Computing (RISC) processor, an Application-Specific Integrated Circuit (ASIC) processor, a Complex Instruction Set Computing (CISC) processor, and/or other processors.

In one aspect, the processor 202 is configured to receive a plurality of client-side attributes indicative of a first unique client identifier. Examples of the client-side attributes include but are not limited to navigator data, a plurality of canvas unique client identifiers, and a plurality of WebGL unique client identifiers. In another aspect, the first unique client identifier is a browser identifier. In an exemplary embodiment, a “browser” may constitute any user interface, including a web browser.

The processor 202 is configured to generate based on pre-processing data, a first tampering signal confidence value based on the client-side attributes collected for the first unique client identifier. In an embodiment, the processor 202 is configured to transmit an instruction to execute a client-side tamper detection script to generate the first tampering signal confidence value. The processor 202 is configured to transmit the first unique client identifier and one or more secondary attributes to a server. Examples of the secondary attributes include but are not limited to a screen height, a screen width, a navigator platform, and WebGL data.

The secondary attributes may be indicative of a second unique client identifier. In an embodiment, the second unique client identifier is a device-unique client identifier. The processor 202 is configured to combine the one or more secondary attributes with additional networking information of a client, wherein the additional networking information comprises one or more of an Internet Protocol (IP) address of a client device 110 and a Transport Layer Security (TLS) fingerprint of the client device 110. The processor 202 is configured to create the second unique client identifier based on the secondary attributes, the IP address, and/or the TLS fingerprint of the client device. The processor 202 is configured to determine that a second unique client identifier signal strength value of the client device 110 meets a pre-determined threshold value. The predetermined threshold value represents the application's tolerance that a shared IP address, anonymized IP address, a VPN traffic source, or a manipulated network connection, be used for fingerprint matching. The processor 202 may apply an additional signal. The processor 202 may reduce the second unique client identifier signal strength upon determining one or more of an association of the IP address with a virtual private network (VPN), an identification of the IP address as a shared IP address, an identification of an anonymized traffic source, an identification of a manipulated network connection, and an identification of one or more manipulated network attributes. Responsive to determining the second unique client identifier of the client device 110 meets the threshold value, the processor is configured to determine that one or more of the first unique client identifier and the second unique client identifier are not present in a database 102. The processor 202 is configured to create a third unique client identifier responsive to determining that the first unique client identifier and the second unique client identifier are not present in the database 102. The processor 202 may create the third unique client identifier by combining the first unique client identifier and the second unique client identifier to track the malicious user, for example, by generating a universally unique identifier (UUID) and assigning the newly generated UUID to the first client identifier and the second client identifier, such that any future search against either the first client identifier or the second client identifier will return the UUID that represents the third unique client identifier. According to one aspect, the third unique client identifier is a universally unique identifier (UUID). The processor 202 may store the first unique client identifier, second unique client identifier, and the third unique client identifier in the database.

In an embodiment, the processor 202 is configured to retrieve the third unique client identifier from the database 102 responsive to determining that the one or more of the first unique client identifier, and the second unique client identifier are present in the database 102.

In one aspect of the present disclosure, the processor 202 is configured to transmit a command to a backend server 108 to trigger the query to the database to determine whether the first unique client identifier is present in the database, responsive to determining that the second unique client identifier of the client device 110 does not meet the threshold value.

According to another aspect of the present disclosure, the processor 202 is configured to create the third unique client identifier responsive to determining that the first unique client identifier is not present in the database 102.

The processor 202 is configured to retrieve the third unique client identifier from the database 102, responsive to determining that the first unique client identifier is present in the database 102. In an embodiment, the third unique client identifier is created upon determining that the first unique client identifier does not exist in the database 102. In another embodiment, the third unique client identifier is created when the second unique client identifier has an adequate signal strength and the second unique client identifier is also not found in the database.

The memory 204 comprises suitable logic, circuitry, interfaces, and/or code that may be configured to store the set of instructions, which are executed by the processor 202. In an embodiment, the memory 204 may be configured to store one or more programs, routines, or scripts that are executed in coordination with the processor 202. The memory 204 may be implemented based on a Random-Access Memory (RAM), a Read-Only Memory (ROM), a Hard Disk Drive (HDD), a storage server, and/or a Secure Digital (SD) card.

The transceiver 206 comprises suitable logic, circuitry, interfaces, and/or code that may be configured to receive the data related to the first unique client identifier, second unique client identifier, and the third unique client identifier from the database 102, via the communication network 106. The transceiver 206 may be further configured to transmit the data related to the first unique client identifier, second unique client identifier, and the third unique client identifier to one or more display screens of the backend server 108, via the communication network 106. The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet, and/or a wireless network, such as a cellular telephone network, a wireless local area network (LAN), and/or a metropolitan area network (MAN). The wireless communication may use any of a plurality of communication standards, protocols, and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The tracking unit 208 comprises suitable logic, circuitry, interfaces, and/or code that may be configured to track users to identify if their digital activities are suspicious. The input/output unit 210 comprises suitable logic, circuitry, interfaces, and/or code that may be configured to provide one or more inputs to the server 104 during the creation and transmission of the data related to the first unique client identifier, second unique client identifier, and the third unique client identifier. The input/output unit 210 comprises various input and output devices that are configured to communicate with the processor 202. Examples of the input devices include, but are not limited to, a keyboard, a mouse, a touch screen, a microphone, a camera, and/or a docking station. Examples of the output devices include, but are not limited to, a display screen and/or a speaker.

A person skilled in the art will understand that the scope of the disclosure should not be limited to the generation, transmission, and processing of data related to the first unique client identifier, second unique client identifier, and the third unique client identifier based on the aforementioned factors and using the aforementioned techniques. Further, the examples provided in the specification are for illustrative purposes and should not be construed to limit the scope of the disclosure.

This disclosure further describes an exemplary implementation detail of the present system and method for tracking a malicious user, wherein the first unique client identifier is referred to as a “fingerprint A”, the second unique client identifier is referred to as a “fingerprint B”, and the third unique client identifier is referred as a “fingerprint C”.

Thus, in an exemplary implementation, data related to client-side attributes are collected which is used for an initial fingerprint. This fingerprint is called fingerprint A. Examples of the data that is collected include but are not limited to navigator information, canvas fingerprints, and WebGL fingerprints. Then a client-side tamper detection script is executed to determine which attributes in fingerprint A were tampered with. If fingerprint A is collected from a web browser, this will involve running fingerprinting code from two different execution contexts (a worker scope and a global scope) and finding discrepancies in the attribute values. Any tampered values in the global scope are superseded by the actual values found in the worker scope. For example, a client is using a bot to override an actual user-agent value. In an embodiment, the actual user-agent value is retrieved from the worker scope for accurate fingerprinting. Accordingly, this technique may be applied to the other client-side attributes used in obtaining the fingerprint of the client device.

After the tamper detection and any additional pre-processing (which includes, but is not limited to, the removal of extraneous data) are completed, the client device may transmit fingerprint A to a server-side endpoint, along with secondary attributes to be used for fingerprint B. The secondary attributes include, but are not limited to, screen height, screen width, navigator platform, client timezone, client language settings, and WebGL information (e.g., the MAX_VERTEX_ATTRIBS property from the browser's WebGL context, which indicates the graphics card's ability to handle complex vertex data).

The server-side script may cause the processor 202 to combine the secondary attributes with the client device's IP address to construct fingerprint B. The processor 202 may apply an additional signal to the fingerprint B to determine the strength of the client device's fingerprint. If the IP address is associated with a VPN or is known to be a shared IP, or if the processor determines that the traffic may be anonymized using any other means (e.g. TOR exit node detection), then the signal strength of fingerprint B is reduced.

If fingerprint B has sufficient signal strength (no anonymous IP or VPN), then the backend server transmits a query to the database to determine whether or not fingerprint A or fingerprint B exists in the database. If neither fingerprint A nor finger B exists in the database, the system may create a unique UUID, which is called fingerprint C. Fingerprint C will be stored in the database, along with fingerprint A and fingerprint B. If either fingerprint A or fingerprint B already exists in the database, the system may retrieve from the database their parent fingerprint, fingerprint C.

If fingerprint B does not have sufficient signal strength, then the backend server will query the database to determine whether or not fingerprint A exists in the database. If fingerprint A does not exist, the system may create a unique UUID referred to in the present disclosure as fingerprint C. The database stores data related to fingerprint C and fingerprint A. If fingerprint A does exist, the system may then retrieve the parent fingerprint, fingerprint C from the database.

In an embodiment, responsive to determining that multiple fingerprint C's are found in the database, the system may collect the multiple fingerprint C's and aggregate the multiple into a single fingerprint C, or choose to return one or more of the fingerprint C's.

In an embodiment, the fingerprint C is a higher-level fingerprint that can be used for user tracking. While conventional digital fingerprint detection systems may utilize a client device-only fingerprint, a device-only fingerprint, or a hybrid fingerprint, according to aspects of the present disclosure the present system may utilize the fingerprint C, which is a higher-level fingerprint usable for user tracking. According to an embodiment, the fingerprint C is a handprint that acts as a unique identifier with multiple fingerprints attached to it. In an embodiment, the processor may match fingerprint C through a plurality of additional identifiers including but are not limited to proprietary user identifiers, email addresses, and web3 wallet addresses.

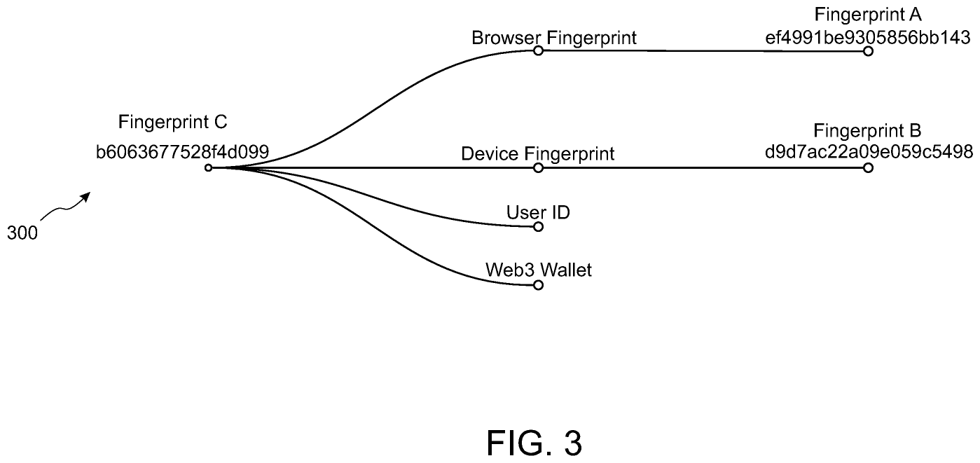

FIG. 3 illustrates a perspective view 300 of the creation of the third unique client identifier by combining the first unique client identifier, and the second unique client identifier for tracking a malicious user, in accordance with at least one embodiment. FIG. 3 is explained in conjunction with FIG. 1 and FIG. 2. FIG. 3 depicts how the processor may combine fingerprint A (client/browser fingerprint) and fingerprint B (client device's fingerprint) using the attributes and methods discussed above to create a fingerprint C that is used for user tracking.

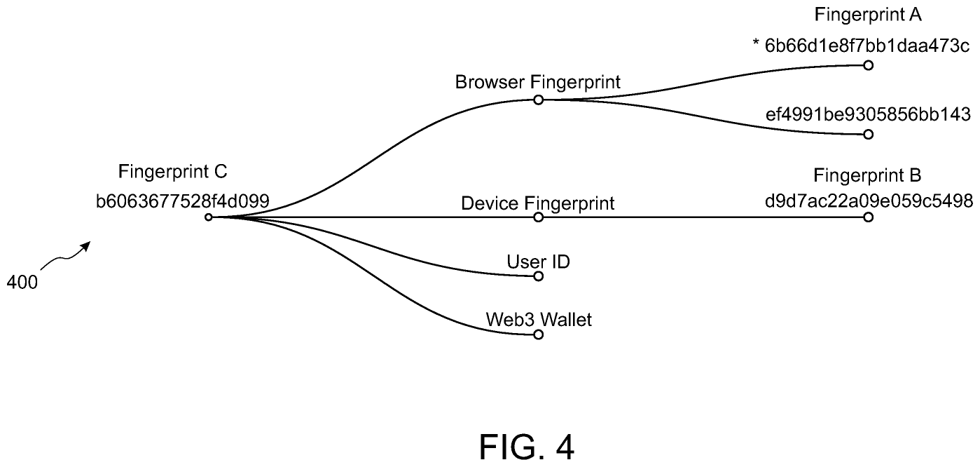

FIG. 4 illustrates a perspective view 400 of tracking the malicious user even if the client and browser changes, in accordance with at least one embodiment. FIG. 4 is explained in conjunction with FIG. 1 and FIG. 2. FIG. 4 depicts that the malicious users can be tracked even if the client device and the client or browser change. Thus, if the client or browser (fingerprint A) changes, the system may utilize the client device's fingerprint (fingerprint B) to establish the user's identity (fingerprint C).

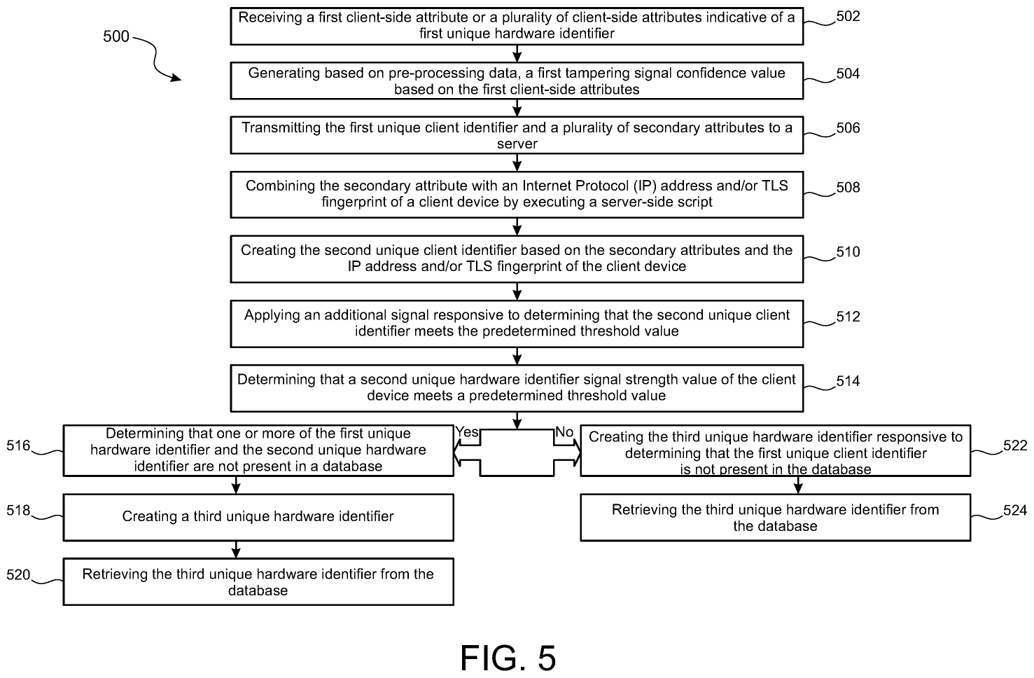

FIG. 5 is a flowchart 500 illustrating a method for tracking a malicious user, in accordance with at least one embodiment. The method includes a step 502 that may include receiving, by a processor, a first client-side attribute or a plurality of client-side attributes indicative of a first unique client identifier. Examples of the client-side attributes can include but are not limited to navigator data, a plurality of canvas unique client identifiers, and a plurality of WebGL unique client identifiers. In an embodiment, the first unique client identifier may be a browser or user interface identifier.

The method can further include a step 504 that may include generating, by the processor, based on pre-processing data, a first tampering signal confidence value based on the first client-side attributes collected for the first unique client identifier. The method can include a step 506 of transmitting, by the processor, the first unique client identifier and one or more secondary attributes to a server. Examples of the secondary attributes may include but are not limited to a screen height, a screen width, a navigator platform, and WebGL data. The secondary attributes are indicative of a second unique client identifier.

The method may further include a step 508 that includes combining, by the processor, the secondary attributes with an Internet Protocol (IP) address and/or TLS fingerprint of a client device by executing a server-side script. The processor may, at step 510, create the second unique client identifier based on the secondary attributes and the IP address and/or TLS fingerprint of the client device. In an embodiment, the second unique client identifier is a device-unique client identifier. The method includes a step 512 that may include applying, by the processor, an additional signal. The method includes a step 514 that may include determining, by the processor, that a second unique client identifier signal strength value of the client device meets a predetermined threshold value. The second unique client identifier signal strength is reduced upon determining one or more of an association of the IP address with a virtual private network (VPN), an identification of the IP address as a shared IP address, an identification of an anonymized traffic source, an identification of a manipulated network connection, and an identification of one or more manipulated network attributes. The method includes a step 516 that may include determining that one or more of the first unique client identifier and the second unique client identifier are not present in a database, responsive to determining, by the processor, the second unique client identifier of the client device meets a predetermined the threshold value. The method includes a step 518 that may include creating, by the processor, a third unique client identifier responsive to determining that the first unique client identifier and the second unique client identifier are not present in the database. The third unique client identifier is created by combining the first unique client identifier and the second unique client identifier to track the malicious user, for example, by generating a universally unique identifier (UUID) and assigning the newly generated UUID to the first client identifier and the second client identifier, such that any future search against either the first client identifier or the second client identifier will return the UUID that represents the third unique client identifier The method includes a step 520 that may include retrieving, by the processor, the third unique client identifier from the database responsive to determining that the one or more of the first unique client identifier, and the second unique client identifier are present in the database. The method includes a step that may include transmitting, by the processor, a command to a backend server to trigger the query to the database to determine whether the first unique client identifier present in the database, responsive to determining that the second unique client identifier of the client device does not meet a predetermined threshold value. The method includes a step 522 that may include creating, by the processor, the third unique client identifier responsive to determining that the first unique client identifier is not present in the database.

The method includes a step 524 that may include retrieving, by the processor, the third unique client identifier from the database, responsive to determining that the first unique client identifier is present in the database. In an embodiment, the third unique client identifier is created upon determining that the first unique client identifier or the second unique client identifier does not exist in the database. In an embodiment, the third unique client identifier is a universally unique identifier (UUID). In an embodiment, the first unique client identifier, the second unique client identifier, and the third unique client identifier are stored in the database.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular article such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for tracking a malicious user, comprising:
receiving, by a processor, a plurality of client-side attributes indicative of a first unique client identifier;
generating, by the processor, based on pre-processing data, a first tampering signal confidence value based on the client-side attributes collected for the first unique client identifier;
transmitting, by the processor, the first unique client identifier and one or more secondary attributes to a server, wherein the one or more secondary attributes is indicative of a second unique client identifier;
combining, by the processor, the one or more secondary attributes with additional networking information of a client, wherein the additional networking information comprises one or more of an Internet Protocol (IP) address of a client device and a Transport Layer Security (TLS) fingerprint of the client device;
creating, by the processor, the second unique client identifier based on the one or more secondary attributes and the networking identifiers of the client device;
applying, by the processor, an additional signal;
determining, by the processor, that a second unique client identifier signal strength value of the client device meets a predetermined threshold value, wherein the second unique client identifier signal strength is reduced upon determining one or more of an association of the IP address with a virtual private network (VPN), an identification of the IP address as a shared IP address, an identification of an anonymized traffic source, an identification of a manipulated network connection, and an identification of one or more manipulated network attributes;
responsive to determining, by the processor, the second unique client identifier of the client device meets the predetermined threshold value, determining that one or more of the first unique client identifier and the second unique client identifier are not present in a database; and
creating, by the processor, a third unique client identifier responsive to determining that the first unique client identifier and the second unique client identifier are not present in the database, wherein the third unique client identifier is created by combining the first unique client identifier and the second unique client identifier to track the malicious user.

2. The method according to claim 1, comprises a step of transmitting, by the processor, an instruction to execute a client-side tamper detection script to generate the first tampering signal confidence value.

3. The method according to claim 1, comprises a step of retrieving, by the processor, the third unique client identifier from the database responsive to determining that the one or more of the first unique client identifier, and the second unique client identifier are present in the database.

4. The method according to claim 1, comprises a step of transmitting, by the processor, a command to a backend server to trigger the query to the database to determine whether the first unique client identifier is present in the database, responsive to determining that the second unique client identifier of the client device does not meet the predetermined threshold value.

5. The method according to claim 1, comprises a step of creating, by the processor, the third unique client identifier responsive to determining that the first unique client identifier and the second unique client identifier is not present in the database.

6. The method according to claim 1, comprises a step of retrieving, by the processor, the third unique client identifier from the database, responsive to determining that the first unique client identifier is present in the database.

7. The method according to claim 1, wherein the plurality of client-side attributes include but are not limited to navigator data, a plurality of canvas fingerprints and canvas unique client identifiers, and a plurality of WebGL unique client identifiers.

8. The method according to claim 1, wherein the one or more secondary attributes include one or more of the following: a screen height, a screen width, a navigator platform, a client time zone, client language settings, WebGL data, WebGL renderer, and WebGL vendor.

9. The method according to claim 1, wherein the first unique client identifier is a browser identifier.

10. The method according to claim 1, wherein the second unique client identifier is a device-unique client identifier.

11. The method according to claim 1, wherein the third unique client identifier is a universally unique identifier (UUID).

12. The method according to claim 1, wherein the first unique client identifier, second unique client identifier, and the third unique client identifier are stored in the database.

13. A system for tracking a malicious user, comprising:
a processor; and
a memory communicatively coupled to the processor, wherein the memory stores a plurality of instructions, which, on execution, causes the processor to:
receive a plurality of client-side attributes indicative of a first unique client identifier;
generate based on pre-processing data, a first tampering signal confidence value based on the client-side attributes collected for the first unique client identifier;
transmit the first unique client identifier and one or more secondary attributes to a server, wherein the one or more secondary attributes is indicative of a second unique client identifier;
combine the one or more secondary attributes with additional networking information of a client, wherein the additional networking information comprises one or more of an Internet Protocol (IP) address of a client device and a Transport Layer Security (TLS) fingerprint of the client device;
create the second unique client identifier based on the one or more secondary attributes and the networking information (including one or more of the IP address and TLS fingerprint) of the client device;
apply an additional signal;
determine that a second unique client identifier signal strength value of the client device meets a predetermined threshold value, wherein the second unique client identifier signal strength is reduced upon determining one or more of an association of the IP address with a virtual private network (VPN), an identification of the IP address as a shared IP address, an identification of an anonymized traffic source, an identification of a manipulated network connection, and an identification of one or more manipulated network attributes;
responsive to determine the second unique client identifier of the client device meets the predetermined threshold value, determine that one or more of the first unique client identifier and the second unique client identifier are not present in a database; and
create a third unique client identifier responsive to determining that the first unique client identifier and the second unique client identifier are not present in the database, wherein the third unique client identifier is created by combining the first unique client identifier and the second unique client identifier to track the malicious user.

14. The system according to claim 13, wherein the processor is configured to transmit an instruction to execute a client-side tamper detection script to generate the first tampering signal confidence value.

15. The system according to claim 13, wherein the processor is configured to retrieve the third unique client identifier from the database responsive to determining that the one or more of the first unique client identifier, and the second unique client identifier are present in the database.

16. The system according to claim 13, wherein the processor is configured to transmit a command to a backend server to trigger the query to the database to determine whether the first unique client identifier is present in the database, responsive to determining that the second unique client identifier of the client device does not meet the predetermined threshold value.

17. The system according to claim 13, wherein the processor is configured to create the third unique client identifier responsive to determining that the first unique client identifier is not present in the database.

18. The system according to claim 13, wherein the processor is configured to retrieve the third unique client identifier from the database, responsive to determining that the first unique client identifier is present in the database.

19. The system according to claim 13, wherein the plurality of client-side attributes include but are not limited to navigator data, a plurality of canvas fingerprints and canvas unique client identifiers, and a plurality of WebGL unique client identifiers.

20. The system according to claim 13, wherein the one or more secondary attributes include one or more of the following: a screen height, a screen width, a navigator platform, a client time zone, client language settings, WebGL data, WebGL renderer, and WebGL vendor.

21. A non-transitory computer-readable storage medium in a distributed computing system, the non-transitory computer-readable storage medium having instructions stored thereupon which, when executed by a processor, cause the processor to:
receive a plurality of client-side attributes indicative of a first unique client identifier;
generate based on pre-processing data, a first tampering signal confidence value based on the client-side attributes collected for the first unique client identifier;
transmit the first unique client identifier and one or more secondary attributes to a server, wherein the one or more secondary attributes is indicative of a second unique client identifier;
combine the one or more secondary attributes with additional networking information of a client, wherein the additional networking information comprises one or more of an Internet Protocol (IP) address of a client device and a Transport Layer Security (TLS) fingerprint of the client device;
create the second unique client identifier based on the one or more secondary attributes and the IP address of the client device;
apply an additional signal;
determine that a second unique client identifier signal strength value of the client device meets a predetermined threshold value, wherein the second unique client identifier signal strength is reduced upon determining one or more of an association of the IP address with a virtual private network (VPN), an identification of the IP address as a shared IP address, an identification of an anonymized traffic source, an identification of a manipulated network connection, and an identification of one or more manipulated network attributes;
responsive to determine the second unique client identifier of the client device meets the predetermined threshold value, determine that one or more of the first unique client identifier and the second unique client identifier are not present in a database; and
create a third unique client identifier responsive to determining that the first unique client identifier and the second unique client identifier are not present in the database, wherein the third unique client identifier is created by combining the first unique client identifier and the second unique client identifier to track the malicious user.

22. The non-transitory computer-readable storage medium according to claim 21, wherein the processor is configured to transmit an instruction to execute a client-side tamper detection script to generate the first tampering signal confidence value.

23. The non-transitory computer-readable storage medium according to claim 21, wherein the processor is configured to retrieve the third unique client identifier from the database responsive to determining that the one or more of the first unique client identifier, and the second unique client identifier are present in the database.

24. The non-transitory computer-readable storage medium according to claim 21, wherein the processor is configured to transmit a command to a backend server to trigger the query to the database to determine whether the first unique client identifier present in the database, responsive to determining that the second unique client identifier of the client device does not meet the predetermined threshold value.

25. The non-transitory computer-readable storage medium according to claim 21, wherein the processor is configured to create the third unique client identifier responsive to determining that the first unique client identifier is not present in the database.

26. The non-transitory computer-readable storage medium according to claim 21, wherein the processor is configured to retrieve the third unique client identifier from the database, responsive to determining that the first unique client identifier is present in the database.
